(19) United States
(12) Patent Application Publication
(10) Pub. No.: US 2018/0012263 A1
(43) Pub. Date: Jan. 11, 2018

(54) COMPONENT OPTIMIZATION OF BENEFIT COMPUTATION FOR THIRD PARTY SYSTEMS

(71) Applicant: Facebook, Inc., Menlo Park, CA (US)

(72) Inventor: Andrew Donald Yates, San Francisco, CA (US)

(21) Appl. No.: 15/203,786

(22) Filed: Jul. 6, 2016

(51) Int. Cl. G06Q 30/02; G06N 99/00; G06N 7/00

(52) U.S. Cl. CPC G06Q 30/0275; G06Q 30/0246; G06N 7/005; G06N 99/005

(57) ABSTRACT

An online system identifies an impression opportunity for a target user of the online system. The online system accesses predictors for a third party system, each predictor determining a prediction value indicating a likelihood of users to provide a specified benefit to the third party system after a specified timeframe from the performance of a specified type of action by the users at the online system, each predictor trained using a training feature set extracted from an impressions log including metadata for past impression opportunities made to users. The online system determines a combined bid value for the third party system based on prediction values determined by the predictors trained for the third party system. In response to determining that the combined bid value for the third party system is a winning bid value, the online system presents a sponsored content from the third party system to the user.

### BACKGROUND

This disclosure relates generally to online systems, and in particular to component optimization of benefit computation for third party systems.

Certain online systems, such as social networking systems, allow their users to connect to and to communicate with other online system users. Users may create profiles on such an online system that are tied to their identities and include information about the users, such as interests and demographic information. The users may be individuals or entities such as corporations or charities. Because of the increasing popularity of these types of online systems and the increasing amount of user-specific information maintained by such online systems, an online system provides an ideal forum for third parties to increase awareness about products or services to online system users.

However, it is difficult for a third party system or the online system to accurately predict the likelihood of events by a user or to determine a benefit to the third party system of providing a user with content of the third party, such as the likelihood that the user will take a desired action related to the content. Thus, it is difficult to determine how much a third party system should pay for different events or actions the user might take.

### SUMMARY

Embodiments of the invention include an online system that performs component optimization of benefit computation for third party system.

In one embodiment, the online system stores in an impressions log, information regarding actions of different types performed by users of the online system on sponsored content items from a third party system. The actions are actions, such as clicking, viewing, and so on, that users of the online system perform in response to being presented with sponsored content from the third party system.

The online system stores in the impressions log information regarding benefits provided to the third party system by the users of the online system, each benefit being an event desired by the third party system. These benefits may increase a revenue for the third party system, and may include events such as a conversion event.

The online system extracts feature data from the impressions log. The feature data indicates at least a timeframe between occurrences of actions and corresponding benefits in the impressions log. In other words, the feature data indicates how long it took for a user to provide the benefit to the third party system after performing the action at the online system.

The online system trains predictors with the extracted feature data. Each predictor generates a prediction value indicating a likelihood of a specified type of benefit occurring after a specified timeframe and a specified action performed by users of the online system. Each predictor that determines the prediction value for a unique combination of the specified benefit, type of action, and specified timeframe is trained using extracted features from the impressions log related to the corresponding benefit, type of action, and timeframe.

The online system identifies an impression opportunity to present a sponsored content item of a third party system to a target user of the online system. The online system accesses the plurality of predictors for the third party system to determine a plurality of corresponding prediction values for different combinations of benefits, actions, and timeframes.

In one case, each predictor generates a prediction value by determining using the extracted features a first probability of users performing the type of action in response to being presented with an impression of the sponsored content from the third party system, determining using the extracted features a second probability of users providing the specified benefit to the third party system in the specified timeframe, and generating the prediction based on a combination of the first and second probabilities.

The online system determines a combined bid value for the third party system based on the plurality of prediction values determined by the plurality of predictors trained for the third party system. The online system provides the combined bid value for a sponsored content item from the third party system in a content auction, the sponsored content item considered relative to other content items in the content auction for presentation to the target user.

The online system may further determine an attribution value for each of the plurality of prediction values. The attribution value indicates a significance of a corresponding prediction value in causing the benefit to occur. The online system modifies each prediction value by the corresponding attribution value, and generates a combined bid valued based on the modified prediction values.

The online system may, for each predictor, determine an effect of the corresponding type of action and timeframe for the predictor in providing the specified benefit by performing a lift analysis of the type of action and timeframe in causing users to provide the specified benefit. Using this lift analysis, the online system may then generate the attribution value for each prediction value based on the results of the lift analysis for the corresponding predictor.

The online system may, for each prediction value, determining the attribution value to be inversely proportional to the timeframe specified for the corresponding predictor.

The online system may also determine that a threshold number of users provide the benefit to the third party system based on a combination of one type of action and timeframe, with this combination not used in a predictor, and create a new predictor for this combination of the type of action and timeframe.

Finally, in response to determining that the combined bid value for the third party system is a winning bid value, the online system may present a sponsored content from the third party system to the user.

Using such a system, an online system may be able to better estimate the value that users are providing to third party systems. Different third party systems have different audiences of users, and thus computing the value of these users all in the same fashion may not truly provide a calculation that represents the true value of these users. Instead, by determining the prediction values based on various factors, such as actions and timeframes, the online system is able to provide a better and more accurate estimation.

### BRIEF DESCRIPTION OF THE DRAWINGS

FIG. 1 is a high level block diagram of a system environment for an online system, according to an embodiment.

FIG. 2 is an example block diagram of an architecture of the online system 140, according to an embodiment.

FIG. 3 is a block diagram illustrating an exemplary data flow for determining the value of content according to different actions and timeframes.

FIG. 4 is a flowchart of one embodiment of a method in an online system for component optimization of benefit computation for third party systems.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

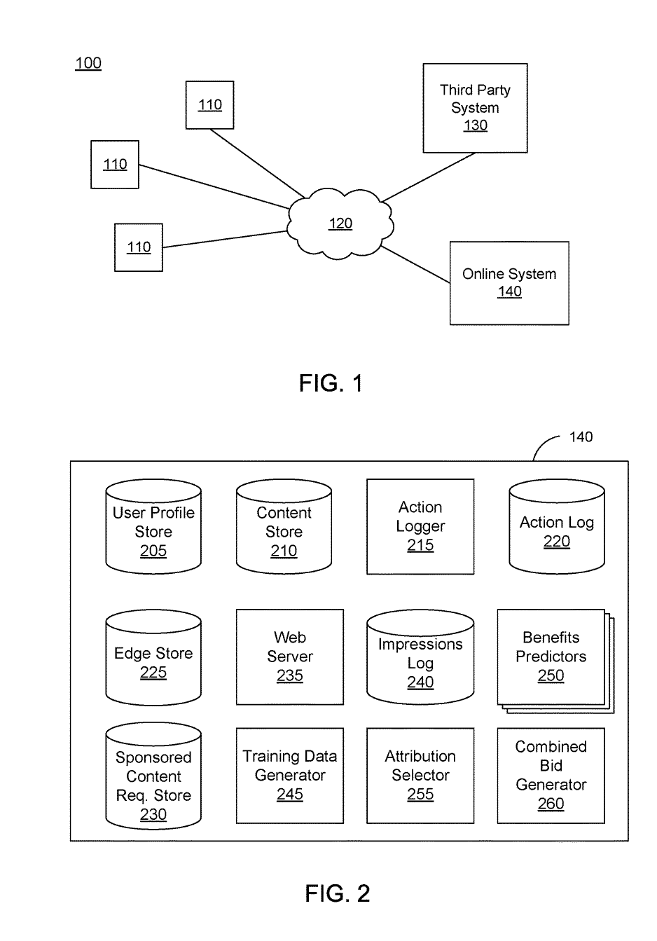

FIG. 1 is a high level block diagram of a system environment 100 for an online system 140, according to an embodiment. The system environment 100 shown by FIG. 1 comprises one or more client devices 110, a network 120, one or more third-party systems 130, and the online system 140. In alternative configurations, different and/or additional components may be included in the system environment 100. In one embodiment, the online system 140 is a social networking system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130, such as a sponsored content provider system, may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130. Specifically, in one embodiment, a third party system 130 communicates sponsored content, such as advertisements, to the online system 140 for display to users of the client devices 110. The sponsored content may be created by the entity that owns the third party system 130. Such an entity may be an advertiser or a company producing a product, service, message, or something else that the company wishes to promote.

FIG. 2 is an example block diagram of an architecture of the online system 140, according to an embodiment. The online system 140 shown in FIG. 2 includes a user profile store 205, a content store 210, an action logger 215, an action log 220, an edge store 225, a sponsored content request store 230, a web server 235, impressions log 240, benefits predictors 250, training data generator 245, attribution selector 255, and combined bid generator 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions are stored in the action log 210. Examples of interactions with objects include: commenting on posts, sharing links, and checking-in to physical locations via a mobile device, accessing content items, and any other interactions. Additional examples of interactions with objects on the online system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website that primarily sells sporting equipment at bargain prices may recognize a user of an online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The sponsored content request store 230 stores one or more sponsored content requests. Sponsored content is content that an entity (i.e., a sponsored content provider) presents to users of an online system and allows the sponsored content provider to gain public attention for products, services, opinions, causes, or messages and to persuade online system users to take an action regarding the entity's products, services, opinions, or causes. In one embodiment, a sponsored content is an advertisement, and the sponsored content request store 230 stores advertisement requests (“ad requests”). An ad request includes advertisement content, also referred to as an “advertisement” and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser (who may be the entity providing the sponsored content) and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies or is used to compute a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The web server 235 links the online system 140 via the network 120 to the one or more client devices 110, as well as to the one or more third party systems 130. The web server 235 serves web pages, as well as other web-related content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 235 may provide application programming interface (API) functionality to send data directly to native client device operating systems, such as IOS®, ANDROID™, WEBOS® or RIM®.

The impressions log 240 stores metadata regarding impressions made to users of the online system 140. Impressions made to the users may include impressions of sponsored content from one or more third party systems 130. Upon being presented with a sponsored content, a user may perform an action against the sponsored content. These actions may include viewing the sponsored content (for a period of time), clicking or interacting with the sponsored content, sharing the sponsored content in the online system 140, indicating a preference (e.g., a like) for the sponsored content, posting a comment regarding the sponsored content, and so on. These actions are stored by the impressions log 240 for each user and each sponsored content.

Additionally, after a period of time, which may be a short period of time, e.g., 10 seconds, or a longer period of time, e.g., 2 weeks, the online system 140 may receive from the third party system 130 that provided the sponsored content an indication of a benefit provided to the third party system 130 by those users who had been presented with the sponsored content from the third party system 130. This benefit may in some cases be referred to as a conversion, and is any event, attribute, or other factor that provides value to a third party system 130. The benefit may be defined by the third party system 130 according to an objective or may be a default benefit indicated by the online system 140. Benefits may include as an app install, a purchase, a click, adding an item to a shopping cart, a particular amount of time spent at the third party system 130, a referral made by the user, signing up for a newsletter, sharing something of the third party system 130 on a social network, performing an action on the online system 140 (e.g., a liking a page on the online system 140 associated with the third party system 130), visiting a particular webpage of the third party system 130, a phone call, an internal search on the third party system 130 using a particular search term, an in-app purchase or event, and so on. The type of benefit provided by each user to a third party system 130 and the timeframe between the action performed at the online system 140 by a user and the occurrence of the benefit provided by the user to the third party system 130 are stored in the impressions log 240.

Note that the occurrence of the benefit and the performance of the action need not be initiated by the same client device 110 of the user. For example, a user may view a sponsored content on a desktop device but make a purchase on a mobile device.

The impressions log 240 may also store other metadata regarding these actions performed by users and the benefits provided to third party systems 130. For example, if the action performed by the user is associated with content on the online system 140 (e.g., viewing a video), the impressions log 240 may store information regarding such content, such as a link to the content, the content itself, and so on. The impressions log 240 may store similar information regarding the benefits provided, such information regarding the purchased item if the benefit provided is a purchase of an item. In some cases, the benefit provided by a user to a third party system 130 may occur after multiple presentations of sponsored content from that third party system 130 to the user. The impressions log 240 stores in such cases each presentation of sponsored content for the user links this to any eventual occurrence of a benefit provided to the third party system 130 by the user.

In other embodiments, the impressions log 240 stores more or less information than the information described above. For example, the impressions log 240 may store only the action and benefit (along with respective timestamps) as described above without storing a timeframe between the action and benefit. In one embodiment, the impressions log 240 is stored in offline storage due to storage requirements (i.e., it is not stored in memory).

The training data generator 245 generates training data from the data in the impressions log 240. The training data generator 245 may standardize the data, may convert the data from a sparse data set to a smaller data set, may apply transforms to the data, and may remove unnecessary data to generate the training data.

In one embodiment, the training data generator 245 standardizes the data in the impressions log 240 to generate the training data. In particular, the training data generator 245 may standardize the indicators in the impressions log 240 indicating the benefits provided by users to the third party system by converting the benefits indicated by the third party into standard types. For example, a third party system 130 may indicate as a benefit “shopped for SKU #12345.” The training data generator 245 may convert this to a benefit of type “purchase.”

In one embodiment, the training data generator 245 converts sparse data in the impressions log into a smaller data set by consolidating one or more types of benefits into a single type. For example, the training data generator 245 may consolidate a benefit indicating “purchase on a mobile device” and “purchase at a non-mobile device” into a single type of benefit indicating a “purchase.” The training data generator 245 may also standardize different actions performed by the user at the online system 140 that are stored in the impressions log 240.

In one embodiment, the training data generator 245 transforms the data in the impressions log 240. In one case, the training data generator 245 converts a timestamp of an action performed by a user at the online system 140 and a timestamp of a benefit received by the third party system 130 from a user into a timeframe between the action performed and the benefit received. This timeframe indicates the duration of time from an action performed by a user in response to presentation of the (last) sponsored content to the user and the occurrence of the benefit to the third party system 130. For example, a user may click on a sponsored content presented to the user at the online system 140 and a time X (e.g., 10:00 am, January 1) and later at a time Y (e.g., 11:00 pm, January 3) the user makes a purchase at the third party system 130. The training data generator 245 computes the difference between the time Y and the time X (e.g., 2 days and 13 hours) to determine the timeframe between the click and the purchase.

In one embodiment, the training data generator 245 performs other actions against the impressions log 240 to generate the training data. This might include removing unnecessary data to generate the training data. For example, the training data generator 245 may remove additional information such as a username, sponsored content identifier, and so on, when generating an entry in the training data indicating an action performed.

In one embodiment, the training data generator 245 transforms the data in the impressions log 240 into training data that is classified numerically. For example, the training data generator 245 may convert the types of actions stored in the impressions log 240 into numbers (e.g., a click is represented by “1,” a view only represented by “2”).

In one embodiment, the training data generator 245 generates training data that includes an action performed by a user at the online system 140 (in response to being presented with the sponsored content), the type of benefit provided by a user to a third party system 130, and the timeframe between the action being performed and the benefit being received.

The benefits predictors 250 make predictions for third party systems 130 regarding the likelihood that a certain type of benefit occurs for a particular type of action performed by a user at the online system 140 in response to being presented with sponsored content from the third party system 130.

Each benefits predictor 250 may be used to generate a separate prediction indicating the likelihood of a certain type of benefit occurring for a third party system 130 within a certain timeframe in response to a certain type of action being performed by a user at the online system 140 after being presented with a sponsored content of the third party system 130. The timeframes may include 1 day, 2-14 day, and 14 days and beyond (or any other combinations of timeframes). As noted, the benefit may be anything that provides a value to a third party system 130, and an action is an action that a user performs on the online system 140 in relation to being presented with a sponsored content from the third party system 130.

Thus, the online system 140 may have multiple benefits predictors 250, with each benefit predictor 250 predicting the likelihood of a benefit occurring for a different type of benefit, action, and timeframe combination.

To make an accurate prediction of the likelihood, each benefits predictor 250 may select data from the training data that corresponds to a single combination of benefit type, action type, and timeframe range for a particular third party system 130. In another embodiment, each benefits predictor 250 retrieves similar data directly from the impressions log 240.

An example of a particular benefits predictor is one that estimates the occurrence of a purchase at a third party system 130 (the benefit) due to a click (an action) by a user against a sponsored content provider occurring within the most recent 2-14 days (the timeframe).

In one embodiment, each benefits predictor 250 predicts the likelihood by first determining a first probability of the type of action being performed by users given an impression of a sponsored content of a third party system 130 to the users. The benefits predictor 250 may utilize the training data or the data in the impressions log 240 to determine a total number of impressions of sponsored content of the third party system 130 that have been presented to users, and determine how many of these result in the action being performed by a user.

The benefits predictor 250 may also determine a second probability of the particular type of benefit occurring given that the particular type of action has occurred in the particular timeframe. The benefits predictor 250 may again utilize the training data or the impressions log 240 to determine a number of the particular type of action performed by users for the third party system 130, and a number of the particular type of benefit occurring within the particular timeframe.

The benefits predictor 250 may combine these two probabilities (e.g., by multiplying their values together) in order to generate the likelihood of a particular combination of benefit, action, and timeframe for a third party system 130 given that impressions of the third party system 130 were made to the users for which the likelihood is being calculated.

In one embodiment, each benefits predictor 250 uses a subset of the training data or the data from the impressions log 240 when determining the above-mentioned probabilities. The subset of the data may be data from a particular range of timestamps (e.g., the last 30 days).

Each benefits predictor 250 may use a different or modified method to generate the predictions. In one embodiment, a benefits predictor 250 includes a regression model (e.g., a multidimensional logistic regression model) fitted to the data in the impressions log 240 or the training data. The regression model is used to determine the probability of a particular benefit occurring for a particular combination of action and timeframes.

In one embodiment, the attribution selector 255 determines an attribution value for one or more of the likelihood predictions made by the benefits predictors 250. The attribution value indicates how significant different combinations of types of actions and timeframes are in causing a type of benefit to occur for a third party system 130. For example, in the case where the benefit is a purchase for a third party system 130 selling luxury goods, a click type action and a timeframe of 1 day would likely be less significant in causing the purchase to occur, compared to a 2-14 day timeframe with a view action. This may be attributed to the fact that users typically do not purchase expensive luxury goods impulsively, but may consider the potential purchase before possibly making it.

To determine the attribution for each benefits predictor 250, the attribution selector 255 may allow the advertiser or third party to determine their own attribution multipliers, or may use industry best practices attribution multipliers as defaults. The attribution selector 255 may also determine the attribution by starting with initial attribution multipliers based on industry best practices and that, in sum total, roughly equals the attributed number of benefit events estimated in lift studies. Using a feedback-loop approach, after delivering sponsored content based on bid values computed from these initial attribution estimates, the attribution selector 255 makes automated adjustments to the bid values to prevent over or under bidding, subject to: 1) the difference between total number of attributed benefit events predicted and the number of attributed conversions estimated in further, future lift studies is minimized, and 2) the measured attributed conversions per impression is maximized. Additionally, this automated approach may use a Bayesian-Gaussian Process informed by past results and results from other campaigns run by other similar advertisers or other parameter searching techniques in optimization.

In another embodiment, the attribution selector 255 may perform a lift analysis to determine the attribution. The lift analysis determines the “lift,” or increase in the benefit, provided to a third party system 130 due to the presentation of a sponsored content to users.

In one case, to perform the lift analysis, the attribution selector 255 may exclude some users that qualify for the targeting criteria of a sponsored content from being shown the sponsored content of the third party system 130. The attribution selector 255 may measure the difference in an amount of benefit provided to the third party system 130 between the excluded users and the non-excluded users. The benefit measured is the type of benefit predicted by the benefits predictor 250. The difference determined by the attribution selector 255 is the amount of lift that showing the sponsored content to users creates. The attribution selector 255 may further exclude those cases of lift where a user was shown multiple instances of sponsored content. The attribution selector 255 determines the attribution for each action and timeframe combination based on the amount of lift above the average lift that the particular combination provides. This may indicate that this particular combination of action and timeframe influences users to provide a greater benefit for the third party system 130. Thus, the attribution for benefits predictors 250 with this combination of action and timeframe may have higher attribution values.

In one embodiment, the attribution selector 255 assigns a higher attribution value based on the timeframe for which an action occurred. The attribution selector 255 may assign a higher attribution value for shorter timeframes. The reason for this is that those actions performed closer in time to when the benefit occurred may be more likely to have been more significant in causing the benefit to have occurred. Thus, the attribution selector 255 may assign higher attribution values to those benefits predictors 250 that are associated with shorter timeframes.

The combined bid generator 260 generates a combined bid value based on the predictions made by the appropriate benefits predictors 250 and the attribution value associated with each prediction. In one embodiment, the combined bid generator 260 multiplies each prediction by the corresponding attribution value, and sums the resultant values together to generate a summed bid value. Additionally, the combined bid generator 260 may also standardize the attribution values or the output values from the benefits predictors 250. This may include computations such as capping the prediction range to be between 0 and 1, and so on. the attribution selector 255 may transform the bid prediction components from the model space to their actual true value that they represent (if any such transformation is necessary). For example, if one benefits predictor 250 output is modeled as the positive square root of the probability, then the combined bid generator 260 may square the resulting model output when computing the combined. Another example is if using an event bid prediction, which is a non-negative real value, the combined bid generator 260 may assume that event bids approximately follow a log-normal distribution. In such a case, the combined bid generator 260 raises the output of the model to the inverse of the natural logarithm (e).

This summed bid value may also be influenced by an average bid value set by the third party system 130. The combined bid generator 260 may adjust the bid value so that an average of the recent bid values within a time window approaches the average bid value set by the respective third party system 130.

In one embodiment, the combined bid generator 260 may also modify the bid value based on other aspects, such as a user's profile preferences regarding the third party system 130 (e.g., positive preferences may increase the bid value).

Additional details regarding determining bid amounts are further described, for example, in U.S. patent application Ser. No. 14/160,510, filed Jan. 21, 2014, which is hereby incorporated by reference in its entirety.

Upon receipt of an impression opportunity for a user of the online system 140, the combined bid generator 260 generates a bid value for a sponsored content of the third party system 130 using one or more benefits predictors 250 as described here. The different types of actions and timeframes used in predicting the benefits for the third party system 130 may be specified by the third party system 130, or may be determined by the combined bid generator 260 based on a determination of the typical timeframes and actions associated with users who provide benefit to that particular third party system 130. If a threshold number of users provide a benefit to the third party system 130 using a particular type of action and timeframe combination, the combined bid generator 260 may specify a benefits predictor 250 to predict a benefit based on such an action and timeframe combination.

The online system 140 may also use a threshold of model prediction quality when deciding to use or not use a particular benefits predictor 250. In one case, the benefits predictor 250 is utilized if it predicts the benefit better than a predictor that uniformly predicts the average rate (e.g., when using a sample data set). The results of a benefits predictor 250 should not be highly correlated with the output of another benefits predictor 250, as no new information would be gained in such a scenario (i.e., one benefits predictor 250 would simply be a scalar multiple of another) Instead, only one of the benefits predictors 250 may be used, with its output prediction increased by some multiple that may correspond to how many benefits predictors 250 correlate with this output.

In one embodiment, the online system 140 uses a threshold of unexplained attributed benefit events as determined by a lift test to enable or suggest the addition of additional benefits predictors 250 for inclusion in the bid value prediction. For example, if the total number of benefit events as determined by a lift test is significantly less than the sum of industry standard one-day post-click conversions, then the online system 140 may simply use one-day post-click with a scalar of less than or equal to one, and the online system 140 will suggest this configuration and an attribution multiplier. Conversely, if the sum of one-day post-click (or whatever the default conversion optimization attribution definition is) is substantially less than the number of attributed benefit events measured in a lift study, then other combinations of actions and timeframes not included in the current conversion optimization attribution definition are likely to account for the additional benefit events, and the system will suggest a configuration with additional actions and timeframes like long term conversion (2-7 day, 2-14 day) or non-click conditional actions (view-thru (no other action), not-click-but-post-dwell, etc.)

If the bid value computed by the combined bid generator 260 for the third party system 130 is a winning bid value for an impression opportunity, then the online system 140 selects a sponsored content for that third party system 130 to present to the user.

Using the system described here, an online system 140 may be able to better determine the value of presenting a sponsored content to a user for a third party system 130. Many users may provide a benefit (e.g., a purchase) to a third party system within a short timeframe (e.g., 1 day) after performing an action regarding a sponsored content (e.g., a click). Note this does not mean that all users of the third party system will provide a benefit to the third party system within the short timeframe, but rather that of those users that do provide a benefit, most do so within the short timeframe. However, for certain third party systems 130 the user response to being presented by a sponsored content may be different. For these third party systems 130, the online system 140 may use the system described here to better estimate the amount of the benefit that may be provided to the third party system 130 upon presentation of the sponsored content. For example, a third party system 130 may be a retailer of high-end goods. Users viewing sponsored content from this retailer may not purchase an item (i.e., provide a benefit) immediately after clicking on the sponsored content. Instead, the user may consider the purchase for a while before making it. Here, the bid value of the sponsored content should account for the potential of the later purchase. As another example, a user may view a sponsored content on a mobile device, and may subsequently make a purchase at the third party system's website on a desktop device, although the sponsored content on the mobile device was an attributable factor for the user to make the purchase at the desktop device. Here, the bid value of the sponsored content should account for the purchase on the separate device.

### Exemplary Block Diagram of Data Flow Illustrating the Determination of a Value of Content According to Different Actions and Timeframes

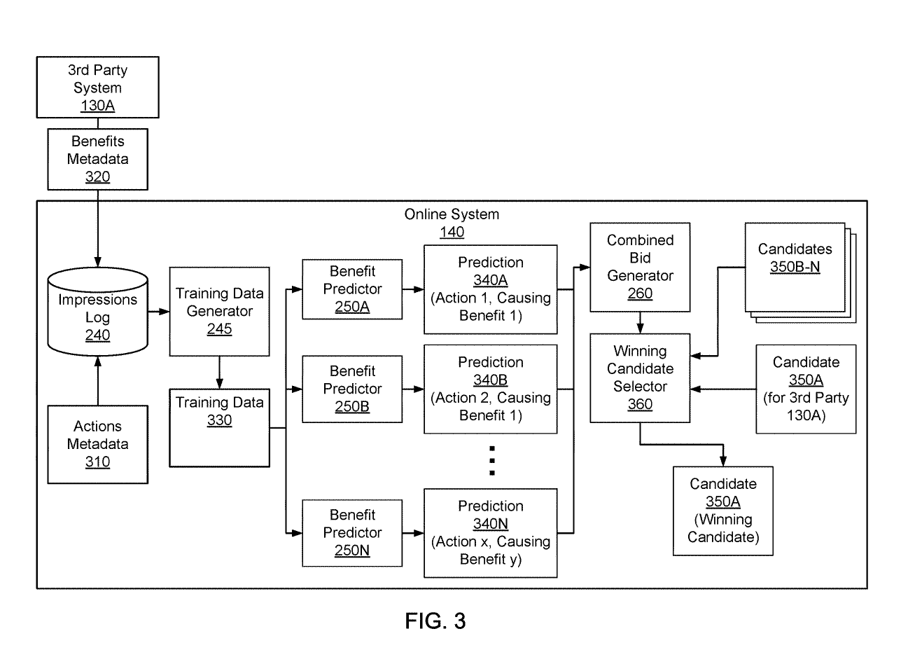

FIG. 3 is a block diagram illustrating an exemplary data flow for determining the value of content according to different actions and timeframes. Although certain elements are illustrated in FIG. 3, in other embodiments the elements may be different and the flow of the data through the elements may be different.

Initially, the online system 140 receives the benefits metadata 320 from the third party system 130A. This benefits metadata 320 includes information regarding the benefit provided by a user to the third party system 130, may include an identifier of the user (which may be hashed to avoid unnecessary disclosure of personally identifiable information), and includes a timestamp at which the benefit occurred. For example, the benefits metadata 320 may identify that a user made a particular purchase (the benefit) at a particular timestamp. The online system 140 stores this information in the impressions log 240.

The online system 140 also stores actions metadata 310 in the impressions log 240. The actions metadata 310 may include information regarding actions performed by users in response to being presented by sponsored content. For example, in relation to the above example, the actions metadata 310 may include an identifier of the user, a click (action) performed by the user against the sponsored content, and the timestamp of the click.

The training data generator 245 accesses the benefits metadata 320 and the actions metadata 310 in the impressions log 240 and generates the training data 330 using this metadata. As noted above, the training data generator 245 may perform various transforms and other actions against the data in the impressions log 240 to generate the training data 330. For example, referring again to the above example, the training data generator 245 may include in the training data the information regarding the third party system 130A indicating a purchase made by the user, the click performed by the user, and a timeframe between the click and the purchase calculated based on the difference of the timestamps indicated in the metadata associated with the benefit and action information. The training data generator 245 may continuously or periodically update the training data based on new information collected in the impressions log 240, and may purge old data from the training data 330.

Each benefit predictor 250 may generate a prediction 340 that predicts the likelihood of a benefit occurring for a third party system 130 based on a combination of action and timeframe. The benefit predictor 250 may predict the likelihood offline, or may make this prediction dynamically after the online system 140 determines that an impression opportunity exists for a user and a prediction should be made for a particular third party system 130. For example, after the online system 140 determines that an impression opportunity exists for a user, one benefit predictor 250A may predict the likelihood that a purchase occurs after a particular timeframe for a third party system 130 that was caused by a click from a user.

The predictions 340 indicate a particular action X that causes a benefit Y within a timeframe Z. In one embodiment, multiple actions and/or benefits may be grouped together into a single category of actions and/or benefits (e.g., different types of actions may be categorized as a single type of action), and a single prediction 340 may be generated for the single category, instead of multiple predictions 340 being generated for each action and benefit combination.

The combined bid generator 260 combines the predictions 340 for each third party system 130 and generates a bid value as described above. This bid value is submitted to the winning candidate selector 360. Each candidate 350 is from a third party system 130, and is associated with the bid value computed by the combined bid generator 260 for that third party system. The winning candidate selector 360 determines the candidate 350 that is associated with the highest bid value and selects this candidate as the winning candidate. In the illustration of FIG. 3, the candidate 350A is the winning candidate.

### Exemplary Flow of a Method of Determining a Value of Content According to Different Actions and Timeframes

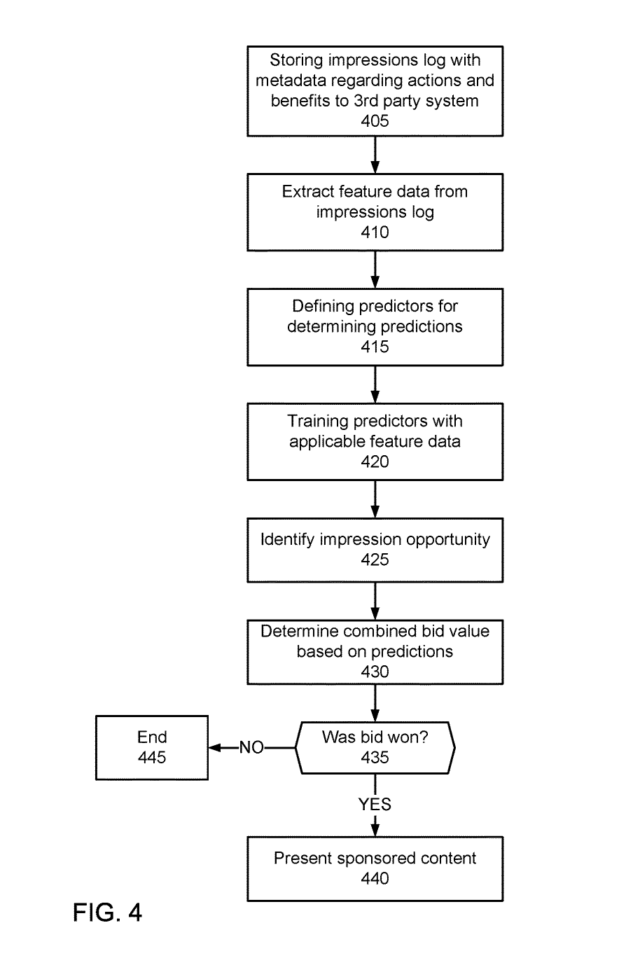

FIG. 4 is a flowchart of one embodiment of a method in an online system for component optimization of benefit computation for third party systems. In other embodiments, the method may include different and/or additional steps than those described in conjunction with FIG. 4. Additionally, in some embodiments, the method may perform the steps described in conjunction with FIG. 4 in different orders. In one embodiment, the method is performed by one or more of the modules of the online system 140 described above.

The online system 140 stores 405 in an impressions log metadata regarding the actions and benefits provided to a third party system by users. As described above, each entry in the impressions log may indicate the benefit provided to the third party, the action performed by the user providing the benefit, an identifier of the user, and timestamps for when the action was performed, and when the benefit was conferred. The benefit may be anything that is of value to the third party system, such as a purchase. The action may be any type of action performed by the user at the online system, such as a click.

The online system 140 extracts 410 feature data from the impressions log. As described above, the features may indicate the timeframe between when an action takes place, and when the benefit is conferred to the third party system by the user. The online system 140 defines 415 predictors (e.g., benefits predictors 250) for determining the predictions indicating the likelihood that a user will provide a benefit to a third party system with a specific action type and timeframe, as described above.

The online system 140 trains 420 the predictors with the applicable feature data from the extracted feature data set. For example, a predictor that predicts the likelihood of a purchase made within 1 day of a click action, would receive features related to purchases, clicks, and timeframes of 1 day between the purchase and click. Note that the training data may include cases where the benefit was provided after the action occurred, within the timeframe specified, or cases where the benefit was not provided within the timeframe specified after the action occurred.

The online system 140 identifies 425 an impression opportunity for a target user. Using the predictors, as described above, the online system 140 may combine multiple predictions to determine 430 a combined bid value based on the predictions. This bid value may be combined from the individual predictions along with corresponding attribution values. If the combined bid value wins 435 the bidding for the impression opportunity, the online system 140 presents 440 sponsored content from the third party system associated with the combined bid value to the user. Otherwise, the process ends 445.

Note that although the process is described here with regards to the predictions for a single third party system, the online system 140 may also determine combined bid values for other additional third party systems, and select the highest (or second highest, etc.) bid value from the multiple combined bid values, and present the sponsored content from the third party system with the winning bid.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing, at an online system in an impressions log, information regarding actions of different types performed by users of the online system on sponsored content items from a third party system;
storing in the impressions log information regarding benefits provided to the third party system by the users of the online system, each benefit being an event desired by the third party system;
extracting feature data from the impressions log, the feature data indicating at least a timeframe between occurrences of actions and corresponding benefits in the impressions log;
training a plurality of predictors with the extracted feature data, each predictor generating a prediction value indicating a likelihood of a specified type of benefit occurring after a specified timeframe and a specified action performed by users of the online system;
identifying, at an online system, an impression opportunity to present a sponsored content item of a third party system to a target user of the online system;
accessing the plurality of predictors for the third party system to determine a plurality of corresponding prediction values for different combinations of benefits, actions, and timeframes;
identifying an impression opportunity to present a sponsored content item to the target user;
determining a combined bid value for the third party system based on the plurality of prediction values determined by the plurality of predictors trained for the third party system; and
providing the combined bid value for a sponsored content item from the third party system in a content auction, the sponsored content item considered relative to other content items in the content auction for presentation to the target user.

2. The method of claim 1, wherein each predictor that determines the prediction value for a unique combination of the specified benefit, type of action, and specified timeframe is trained using extracted features from the impressions log related to the corresponding benefit, type of action, and timeframe.

3. The method of claim 1, wherein each predictor that determines the prediction value for a unique combination of the specified benefit, type of action, and specified timeframe by:
determining using the extracted features a first probability of users performing the type of action in response to being presented with an impression of the sponsored content from the third party system;
determining using the extracted features a second probability of users providing the specified benefit to the third party system in the specified timeframe; and
generating the prediction value based on the combination of the first and second probabilities.

4. The method of claim 1, wherein the determining a combined bid value for the third party system based on the prediction values further comprises:
determining an attribution value for each of the plurality of prediction values, the attribution value indicating a significance of a corresponding prediction value in causing the benefit to occur;
modifying each prediction value by the corresponding attribution value; and
generating a combined bid valued based on the modified prediction values.

5. The method of claim 1, wherein the determining the attribution value for each of the plurality of prediction values is based on initial default attribution values that approximate an attributed number of benefit events estimated in a lift analysis.

6. The method of claim 1, wherein the determining the attribution value for each of the plurality of prediction values further comprises:
for each prediction value, determining the attribution value to be inversely proportional to the timeframe specified for the corresponding predictor.

7. The method of claim 1, further comprising:
determining that a threshold number of users provide the benefit to the third party system based on a combination of one type of action and timeframe, the combination not used in a predictor; and
creating a new predictor for the combination of the one type of action and timeframe.

8. The method of claim 1, further comprising:
in response to determining that the combined bid value for the third party system is a winning bid value, presenting a sponsored content from the third party system to the user.

9. The method of claim 1, wherein the actions are performed at the online system by the users in response to being presented with the sponsored content from the third party system, and wherein the actions include at least one of a click and a view.

10. The method of claim 1, wherein the benefit provided to the third party system increases a revenue of the third party system, the benefit including at least a conversion by one of the users of the online system.

11. A computer program product comprising a non-transitory computer readable storage medium having instructions encoded thereon that, when executed by a processor, cause the processor to:
store, at an online system in an impressions log, information regarding actions of different types performed by users of the online system on sponsored content items from a third party system;
store in the impressions log information regarding benefits provided to the third party system by the users of the online system, each benefit being an event desired by the third party system;
extract feature data from the impressions log, the feature data indicating at least a timeframe between occurrences of actions and corresponding benefits in the impressions log;
train a plurality of predictors with the extracted feature data, each predictor generating a prediction value indicating a likelihood of a specified type of benefit occurring after a specified timeframe and a specified action performed by users of the online system;
identify, at an online system, an impression opportunity to present a sponsored content item of a third party system to a target user of the online system;
access the plurality of predictors for the third party system to determine a plurality of corresponding prediction values for different combinations of benefits, actions, and timeframes;
identify an impression opportunity to present a sponsored content item to the target user;
determine a combined bid value for the third party system based on the plurality of prediction values determined by the plurality of predictors trained for the third party system; and
provide the combined bid value for a sponsored content item from the third party system in a content auction, the sponsored content item considered relative to other content items in the content auction for presentation to the target user.

12. The computer program product of claim 11, wherein each predictor that determines the prediction value for a unique combination of the specified benefit, type of action, and specified timeframe is trained using extracted features from the impressions log related to the corresponding benefit, type of action, and timeframe.

13. The computer program product of claim 11, wherein each predictor that determines the prediction value for a unique combination of the specified benefit, type of action, and specified timeframe by:
determining using the extracted features a first probability of users performing the type of action in response to being presented with an impression of the sponsored content from the third party system;
determining using the extracted features a second probability of users providing the specified benefit to the third party system in the specified timeframe; and
generating the prediction value based on the combination of the first and second probabilities.

14. The computer program product of claim 11, having further instructions encoded thereon that, when executed by a processor, cause the processor to:
determine an attribution value for each of the plurality of prediction values, the attribution value indicating a significance of a corresponding prediction value in causing the benefit to occur;
modify each prediction value by the corresponding attribution value; and
generate a combined bid valued based on the modified prediction values.

15. The computer program product of claim 11, wherein the attribution values are based on initial default attribution values that approximate an attributed number of benefit events estimated in a lift analysis.

16. The computer program product of claim 11, having further instructions encoded thereon that, when executed by a processor, cause the processor to:
for each prediction value, determine the attribution value to be inversely proportional to the timeframe specified for the corresponding predictor.

17. The computer program product of claim 11, having further instructions encoded thereon that, when executed by a processor, cause the processor to:
determine that a threshold number of users provide the benefit to the third party system based on a combination of one type of action and timeframe, the combination not used in a predictor; and
create a new predictor for the combination of the one type of action and timeframe.

18. The computer program product of claim 11, having further instructions encoded thereon that, when executed by a processor, cause the processor to:
in response to the determination that the combined bid value for the third party system is a winning bid value, present a sponsored content from the third party system to the user.

19. The computer program product of claim 11, wherein the actions are performed at the online system by the users in response to being presented with the sponsored content from the third party system, and wherein the actions include at least one of a click and a view.

20. The computer program product of claim 11, wherein the benefit provided to the third party system increases a revenue of the third party system, the benefit including at least a conversion by one of the users of the online system.
